(19) United States
(12) Patent Application Publication
(10) Pub. No.: US 2017/0068870 A1
(43) Pub. Date: Mar. 9, 2017

(54) USING IMAGE SIMILARITY TO DEDUPLICATE VIDEO SUGGESTIONS BASED ON THUMBNAILS

(71) Applicant: Google Inc., Mountain View, CA (US)

(72) Inventors: Tancred Carl Johannes Lindholm, Helsinki (FI); Johan Georg Granström, Zurich (CH); Li Wei, San Jose, CA (US); Yihua Chen, Sunnyvale, CA (US)

(21) Appl. No.: 14/844,178

(22) Filed: Sep. 3, 2015

(51) Int. Cl. G06K 9/46; G06F 17/30; G06T 1/00

(52) U.S. Cl. CPC G06K 9/4671; G06T 1/0007; G06F 17/30247; G06F 17/3053; G06F 17/3028; G06F 17/30153

(57) ABSTRACT

A system and computer program product are provided for improving the utility of video recommendations in a content system via de-duplication of highly similar thumbnail images. For each video added to an online content system, a thumbnail image is generated and stored. For each such thumbnail image a compressed representation is computed. During playback of a video, a set of related videos is generated. For each video in the set, the corresponding thumbnail image and its compressed representation are retrieved. A measure of visual distance is computed for each pair in the set of representations, and measures indicating excess similarity are identified. Similarity is reduced via selective removal of some of the representations. An identification of the thumbnail images and videos corresponding to the remaining representations is produced.

### FIELD OF ART

This invention relates generally to online video or streaming services, and in particular to improving video recommendations by identifying and removing highly similar video thumbnails.

### DESCRIPTION OF THE RELATED ART

Online systems store, index, and make available for consumption various forms of media content to Internet users. This content may take a variety of forms; in particular, video content, including streaming video is widely available across the Internet. Online video systems allow users to view videos uploaded by other users. Popular online content systems for videos include YouTube™.

A common feature of online video systems is the ability to recommend videos to users based on current or previously watched videos and a variety of other factors, examples of which include the video title, content, upload date, author or source, video language, user information, inter-user connection information. These types of recommendation features take a number of different forms and are referred to by a number of different names; some examples include “Watch Next” lists or “Recommended for You” lists. These video recommendation lists generally consist of links to other videos also available on the online video system. By virtue of operation of the recommendation feature, these videos are understood by the online video system to be related in some substantial way to a current or recently-watched video and thus are referred to as “related videos”.

Video recommendations are intended to increase user engagement by encouraging users to watch more videos. Most popular online video systems generate revenue by serving advertisements before, during, or after displaying a video to a user. Increased user engagement—in other words, users watching more videos—directly translates to increased revenue for the online video system as well as for content-producers and other partners.

A persistent problem in video recommendations has to do with providing recommendations in a way that effectively interests users and encourages them to view more videos. A video recommendation in a “Watch Next” or “Recommended for You” list usually takes the form of a static image (or thumbnail) accompanied by a limited amount of text, often the video title or description. The thumbnail thus represents the related video, and can be highly determinative of user interest in the related video. Interaction with the thumbnail from a user causes the linked video to be played back. In many cases, thumbnail images displayed on the webpage of an online video system are very similar (if not identical) to one another, making it difficult for a user to decide which related video to watch next. This problem is evident across a wide range of video categories. One example is sports, where thumbnails corresponding to highlight videos of a particular sport look exactly the same. Thumbnail images for two videos, each of two different soccer matches, both feature players scattered over a green background. To take another example, news videos featuring a particular news anchor are generally represented by thumbnails that feature the same man or woman sitting behind a desk. Although two different videos may feature the anchor speaking about completely different topics, the thumbnails look nearly identical and offer little to no utility to a user in deciding which video to select from the recommendation list. Thus, highly similar thumbnails reduce the utility of video recommendations in online video systems.

### SUMMARY

Embodiments of the invention include a system and method for improving the utility of video recommendation lists in an online content system by de-duplicating highly similar thumbnail images. A video is added by a user to a front-end server of a content system. A back-end server of the system contains a thumbnail generator, a compression module, and a de-duplication module. The thumbnail generator of the content system produces a thumbnail image representative of the video. The compression module then receives the thumbnail image from the thumbnail generator and computes a compressed representation of the thumbnail image. The compression module stores the video, the thumbnail image and its associated compressed representation in a back-end database of the content system.

Asynchronously, the content system displays videos to a user upon request as the user navigates through one or more webpages of the content system. For each video displayed to a user, the content system generates a video recommendation list including related videos that the content system determined to be relevant to the current video. For each video in the list, the de-duplication module retrieves the thumbnail image and its associated compressed representation from the back-end database. The de-duplication module then computes a measure of visual distance for each unique pair of compressed representations in the set of representations. The module compares each computed measure of visual distance against a threshold value, and distances below the threshold value are identified. Based on the set of measures of visual distance below a threshold, the module removes selected representations from the set of representations in order to reduce similarity of the thumbnail images to an acceptable level. Subsequently, the de-duplication module provides to the front-end server an identification of the videos and thumbnail images corresponding to the remaining representations. The front-end server displays the thumbnail images, each thumbnail linking to its associated video, on a webpage of the content system.

In another embodiment, subsequent to reducing similarity via selective removal of highly similar representations, the de-duplication module may itself provide the remaining representations and/or thumbnail images to the front-end server of the content system. The front-end server of the content system may then provide the received thumbnail images in a video recommendation list as part of a webpage provided to a user via a client computing device.

### BRIEF DESCRIPTION OF THE DRAWINGS

FIG. 1 illustrates a computing environment including a content system and a plurality of client devices, according to one embodiment.

FIG. 2 illustrates the logical components of a content system, according to one embodiment.

FIG. 3 illustrates a video digestion process carried out by a content system, according to one embodiment.

FIG. 4 is a flowchart illustrating the video digestion process of FIG. 3, according to one embodiment.

FIG. 5 illustrates the process of de-duplicating video suggestions using thumbnails and associated compressed representations, according to one embodiment.

FIG. 6 is a flowchart illustrating the process of de-duplicating video suggestions using thumbnails and associated compressed representations of FIG. 5, according to one embodiment.

FIG. 7 illustrates a process of removing from a selection of related videos a subset based on thumbnail images that are too similar, according to one embodiment.

FIG. 8a illustrates a view of a content system comprising a current video and a set of suggested videos with no de-duplication, according to one embodiment.

FIG. 8b illustrates a view of a content system comprising a current video and a set of suggested videos with de-duplication, according to one embodiment.

### DETAILED DESCRIPTION

### Environment of an Online Content System

A typical web computing environment contains a variety of different types of media that is accessible through many different types of computing devices to a user accessing the Internet through a software application. This media could be news, entertainment, video (streaming or otherwise), or other types of data commonly made available on the Web. Media in the form of video may be streamed and/or uploaded by users to a content system for viewing by other users of the content system. Videos can be made available to other users to view via the content system. YouTube™ is one example of a video content system available on the Internet. Each allows users to browse through and view videos covering a wide variety of topics.

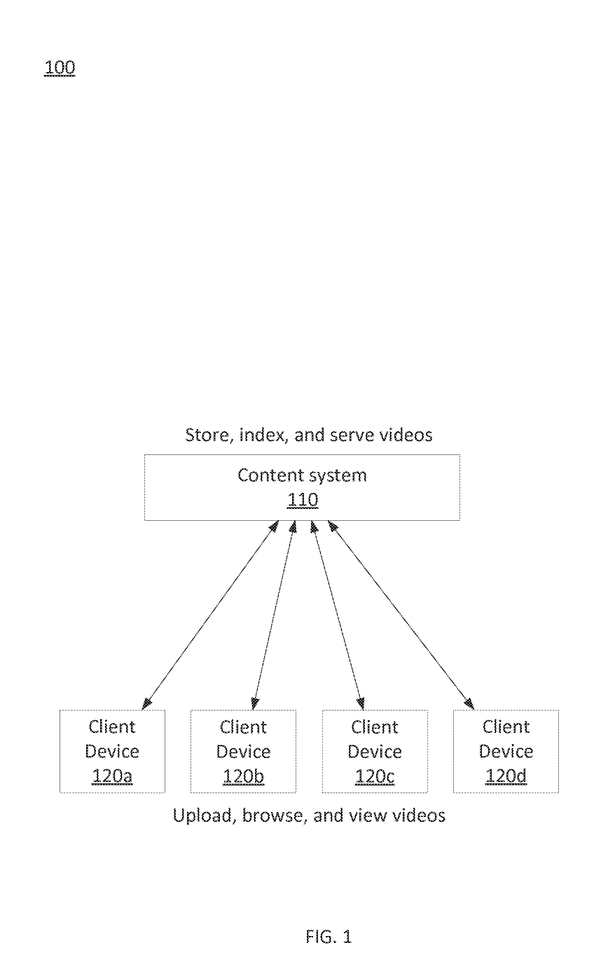

FIG. 1 illustrates a computing environment including a content system and a plurality of client devices, according to one embodiment. The environment 100 comprises a content system 110 and four client devices 120a, 120b, 120c, and 120d. Users operating on client devices 120 may upload, browse, and view videos. The content system 110, responsive to user interaction from users operating on the client devices 120, can store, index, and serve videos.

### Structure of an Online Content System

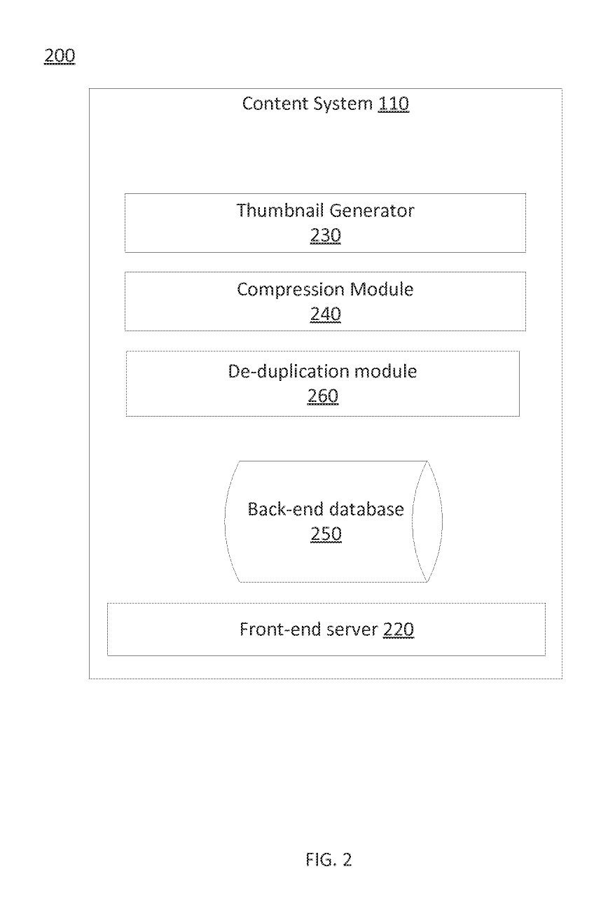

A content system designed to serve videos to users in an online environment includes a number of hardware and logical components. FIG. 2 illustrates the content system of FIG. 1, according to one embodiment. The environment 200 of FIG. 2 comprises the content system 110, which is capable of ingesting videos uploaded by users, indexing them in an organized manner, and storing them in a way that allows for timely retrieval. In one embodiment, the content system 110 comprises a front-end server 220, a thumbnail generator 230, a compression module 240, a back-end database 250, and a de-duplication module 260.

The front-end server 220 receives videos uploaded by users and allows users to browse and view uploaded videos. Videos may be fixed-length or be streamed. The thumbnail generator 230 takes as input a new or updated video and generates a thumbnail image describing the video. The thumbnail image is displayed as a link on a webpage served by the front-end server 220; a user clicking on the thumbnail image causes its corresponding video to be played by the content system 110.

The compression module 240 interfaces with the thumbnail generator 230 by receiving generated thumbnail images, and generating for each thumbnail image a compressed representation. The de-duplication module 260 takes as input a set of compressed representations, each representation corresponding to a different thumbnail image, and compares them to identify and remove highly similar thumbnail images. The back-end database stores thumbnail images and their corresponding representations.

In typical embodiments, the thumbnail generator, compression module, and de-duplication module can each communicate independently with the back-end database and retrieve thumbnail images or compressed representations as needed. Information may also be transferred between the components as required.

### Video Digestion in a Content System

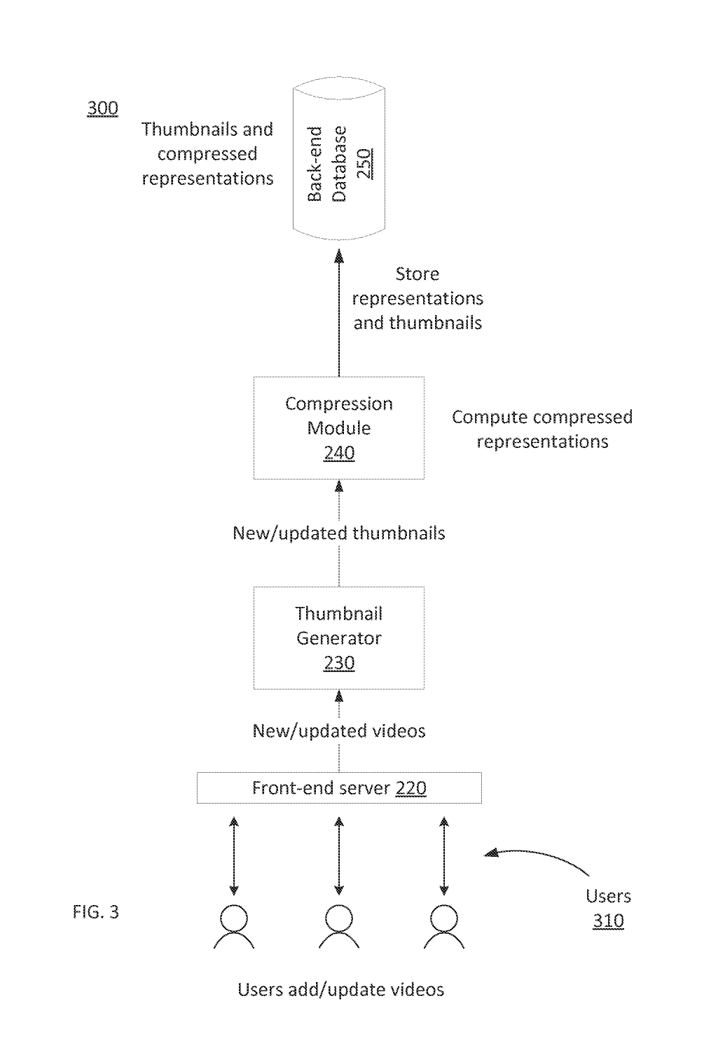

The content system performs video digestion to make the video available for consumption by users. FIG. 3 illustrates a video digestion process in a content system, according to one embodiment. To begin the process, users 310 add or update videos to the front-end server 220 of the content system 110 using their client devices 120. These new or updated videos are then transmitted to the thumbnail generator 230 within the content system. The thumbnail generator 230 produces, for each video, a single thumbnail image representative of the video. In one embodiment, this thumbnail image may be based on a single frame of the input video. Other embodiments may involve the use of multiple (or in some cases, all) frames of the video to generate the thumbnail image. The thumbnail generator 230 transmits the generated thumbnail to the compression module 240 of the content system.

The compression module 240 takes the thumbnail image as input and performs a series of computations to produce a compressed representation corresponding to the inputted thumbnail image. In typical embodiments, the compressed representation is expressed as a feature vector containing multiple parameters. The parameters collectively describe spatial and graphical parameters describing the thumbnail image using fewer bits of data than would be required to otherwise store the thumbnail image on its own. In one embodiment, the computations performed by the compression module 240 to produce each compressed representation include one or more dimensionality reduction or quantization steps. In some embodiments, the technique of principal component analysis may be employed to produce a compressed representation, in conjunction with the previously described techniques. Once the compressed representation has been computed, it is stored by the compression module 240 in the back-end database 250 along with its corresponding thumbnail image and the uploaded/updated video itself.

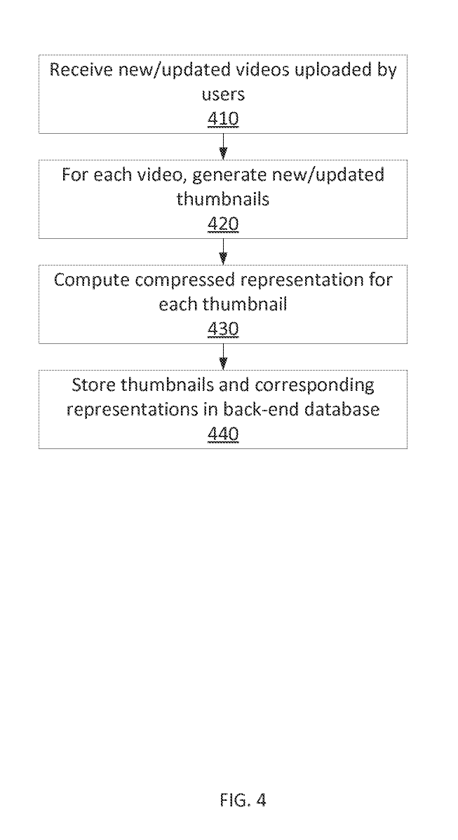

FIG. 4 is a flowchart illustrating a video digestion process in a content system, according to one embodiment. The content system receives 410 new or updated videos updated by users. Users may upload the videos using the front-end server of the content system, according to previously described embodiments. For each video, new or updated thumbnails are generated 420. Compressed representations are then computed 430 for each thumbnail. Finally the thumbnails and corresponding representations are stored 440 in the back-end database.

In some embodiments, the previously described video digestion process occurs asynchronous to requests from the front-end server of the content system for a selection of thumbnail images to be displayed on a video page. Generation of thumbnail images and compressed representations, by the thumbnail generator and compression module respectively, may occur in real-time upon addition of new videos by users to the content system. Alternatively, the thumbnail images and compressed representations may be generated offline, for example in batch mode, to ensure availability from the moment videos are made available to users of the content system.

### De-duplication of Video Suggestions Using Compressed Representations

As users navigate through the webpages or mobile application screens provided by the content system, they click on videos that are then provided by the front-end server of the content system. On some webpages or screens on which a video is displayed, the front-end server generates a list of recommended videos for further viewing. The list may be ordered by relevance, using a relevance score associated with each video that has been calculated by the content system. For each video, an associated thumbnail image link is displayed on the webpage. Highly similar videos can have similar thumbnails, reducing utility for the user. The content system 110 de-duplicates thumbnail images in order to ensure visual diversity in the recommendation list.

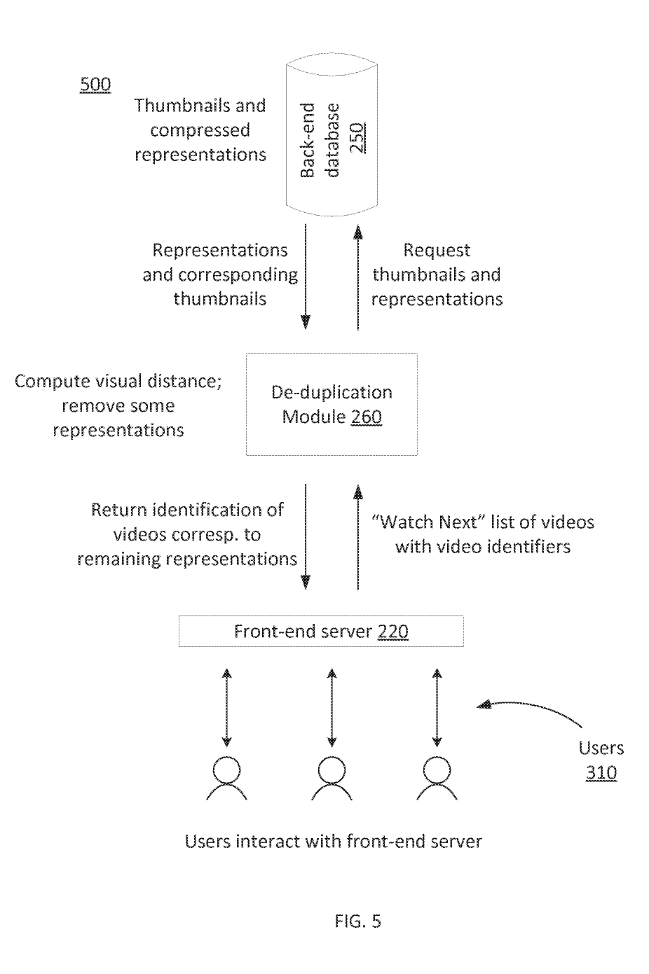

FIG. 5 illustrates a process of de-duplicating video suggestions using thumbnails and associated representations, according to one embodiment. To initiate the process, the de-duplication model 260 receives from the front-end server 220 a recommendation list (also known as a “Watch Next” list) containing an identification of a set of related videos. In order to perform the de-duplication process, the de-duplication module 260 retrieves from the back-end database 250 the compressed representations corresponding to the videos identified in the recommendation list. In one embodiment, compressed representations are generated along with thumbnails during the video ingestion process.

After collecting the appropriate set of compressed representations of the thumbnails corresponding to the identified videos, the de-duplication module 260 compares the visual distance between the compressed representations for the recommended list of videos. Visual distance, as introduced previously, is a quantitative measure of how alike two images are. In the content system, visual distance is computed between compressed representations and not between the original thumbnail images because computation of visual distance between thumbnail images would be computationally intensive, in terms of both computational cycles and storage medium access time, due to the size of each thumbnail image. More specifically, although any given computation of distance between images may not be computationally intensive, it would be computationally intensive to perform such calculations in aggregate across the entirety of the content system, including every time a list of recommended videos must be provided.

De-duplication based on comparison of compressed representations, instead of thumbnail images, offers significant performance advantages. In typical embodiments, computation of a compressed representation according to previously described techniques takes between 100 ms and 500 ms, while comparison between two such compressed representations takes approximately 1 microsecond. Therefore, given a typical recommendation list consisting of 20 thumbnail images, deduplication of the list by comparing previously prepared compressed representations can be performed over 1000 times faster than by comparing the thumbnail images themselves.

Compressed representations, on the other hand, are suitable for performing similarity comparisons at a vast volume without overtaxing available computing power. For example, in a typical embodiment, a visual distance may be computed between two compressed representations by taking the Euclidean distance of the individual feature vectors. A Euclidean distance of 0 between two representations indicates that they are associated with identical images. The greater the distance, the more dissimilar the images. This visual distance may then be used for purposes of comparison. Such a simple calculation is not possible with the original thumbnail images.

In practice, the de-duplication module 260 computes a measure of visual distance as described above for each unique pair of representations in the set of compressed representations for the recommended list of videos. Therefore, for a set of n compressed representations, the de-duplication module computes “n choose 2”, or ₙC₂, quantitative measures of visual distance, each corresponding to one unique pair in the set. In other words, a measure of visual similarity is computed for every unique pair of compressed representations in the set, without reciprocity. The de-duplication module 260 then evaluates each measure of visual distance to determine if it indicates an excessive similarity between two representations. In one embodiment, this is accomplished by defining a threshold value and marking each measure of visual distance that does not exceed the threshold value.

Based on the evaluation, the de-duplication module 260 identifies a subset of measures of visual distance that are considered insufficient. As previously described, each of these measures corresponds to a pair of compressed representations. The de-duplication module 260 selectively removes from each pair one of the representations. For example, if two representations are identified as similar, only one of those representations is removed, so that at least one representation, as well as its corresponding thumbnail and its associated video, remains in consideration for inclusion in the list of related videos. This technique can be extended to alternate embodiments in which more than two compressed representations are considered too similar to one another. In such a situation, only one compressed representation will be retained. It should be noted that removal of a compressed representation and its associated thumbnail image and video only refers to removal from the recommendation list. The compressed representation, thumbnail, and video are retained in the content system for future use.

The representations are removed in such a way as to prioritize more relevant videos over less relevant videos. For example, each of two compressed representations corresponds to a related video as previously described. Of the two videos, one may be considered more relevant to the “currently watched” video than the other, for example based on the relevance score previously calculated by the content system 110. If the visual distance between the compressed representations is below the threshold value, one of the videos must be excluded from the recommendation list. The video considered less relevant will be excluded, and the more relevant video will remain in the list.

The de-duplication module 260 then returns the thumbnails corresponding to those representations and corresponding videos that have not been removed, or an identification thereof, to the front-end server 220. The front-end server 220 displays the thumbnails to one or more of the users 310.

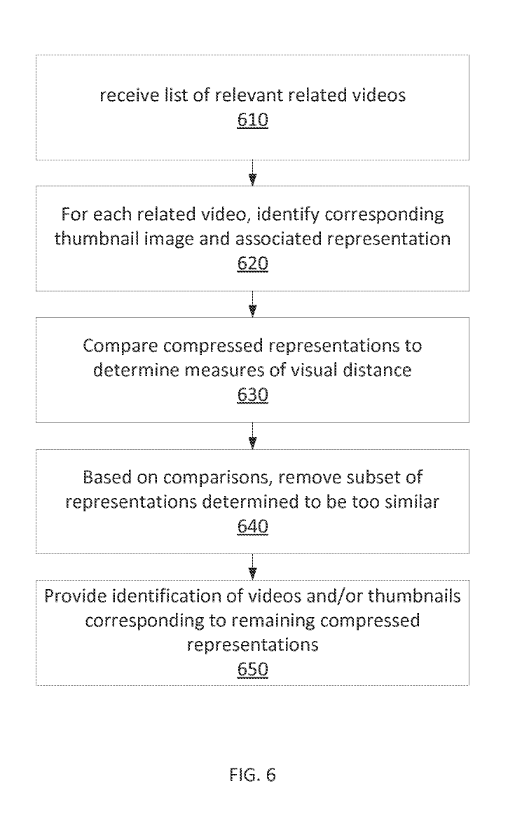

FIG. 6 is a flowchart illustrating the process of de-duplicating video suggestions using thumbnails and associated representations of FIG. 5, according to one embodiment. A de-duplication module within a content system receives 610 a list of relevant videos related to a particular video. For each video in the list of related videos, the de-duplication module then identifies 620 a corresponding thumbnail and its associated compressed representation. These representations may be retrieved from a back-end database or computed dynamically if necessary. The de-duplication module then compares 630 the compressed representations against each other to determine a measure of visual distance for every unique pair in the set of compressed representations. Based on the comparison and the resulting measures of visual distance, the de-duplication module removes 640 a subset of the compressed representations determined to be too similar. Finally, the de-duplication module provides 650 an identification of the videos and the thumbnail images corresponding to the remaining compressed representations.

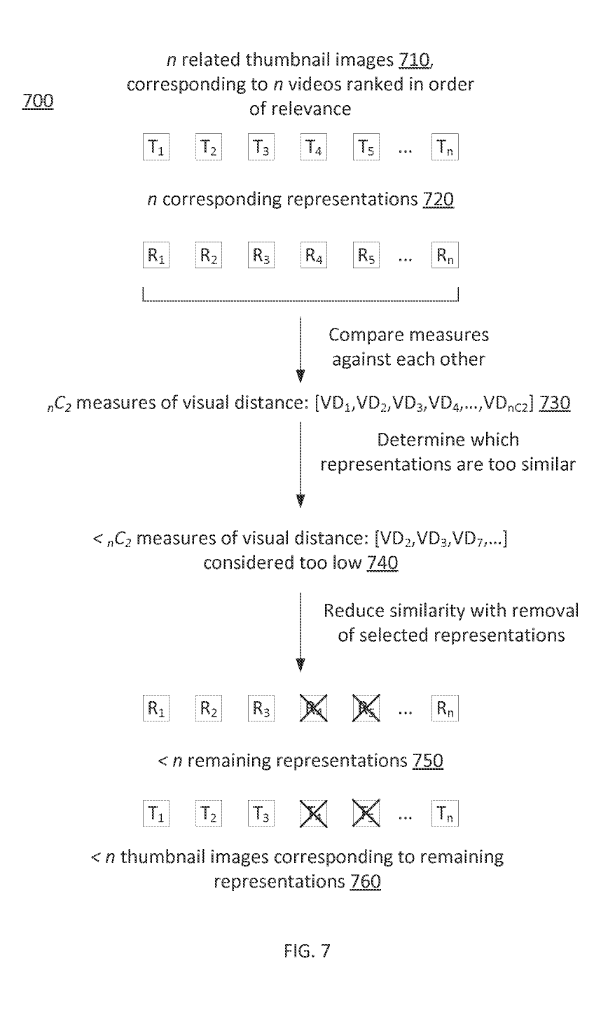

FIG. 7 illustrates the process of removing from a selection of related videos a subset based on thumbnail images that are too similar and subsequently displaying the remaining diverse selection of thumbnail images, according to one embodiment. For every video served or displayed to users of a content system, n thumbnail images 710 are identified, each thumbnail image corresponding to a related video, and are ranked T₁ . . . Tₙ in order of relevance. For each thumbnail image T₁ . . . Tₙ, a corresponding compressed representation is computed, retrieved, or identified, resulting in a set 720 of n representations R₁ . . . Rₙ. Each unique pair of these measures R₁ . . . Rₙ are compared against one another, resulting in a set of ₙC₂ measures of visual distance VD₁ . . . VD_{nC2} 730. From this set 730, a subset 740 of <ₙC₂ measures is identified, the measures corresponding to representations that are too similar to one another. Based on this subset 740 of measures, selected representations are removed from the set 720 of n representations, resulting in a subset 750 of <n remaining representations. For each representation in 750, the corresponding thumbnail image is identified, resulting in a subset 760 of <n thumbnail images. The subset 760 is subsequently displayed on a display screen of a client device.

In another embodiment, measures of visual distance corresponding to commonly occurring pairs of representations may be persisted in order to reduce computational load during subsequent iterations of the de-duplication process. These commonly-occurring measures may be retained by the de-duplication module itself, or else stored in the back-end database and retrieved as required for de-duplication purposes.

### Effect of De-duplication on Video Recommendation

As described in previous embodiments, video de-duplication improves the utility of thumbnail images in video recommendation lists by reducing their similarity. Users may select from videos represented by mostly dissimilar thumbnail images, enhancing the uniqueness of each video suggestion and driving user engagement on the content system. In content systems without de-duplication, video recommendation lists will often end up having multiple videos listed with very similar thumbnails. For example, thumbnail images corresponding to news or sports videos often feature the same or a markedly similar image repeated across multiple thumbnail images, with only slight differences in size, zoom, or cropping of the thumbnail image. This greatly reduces the ability of a user to use the thumbnail image as a means to determine which video to watch next, which has the consequence, in aggregate, of reducing users' engagement with the content system.

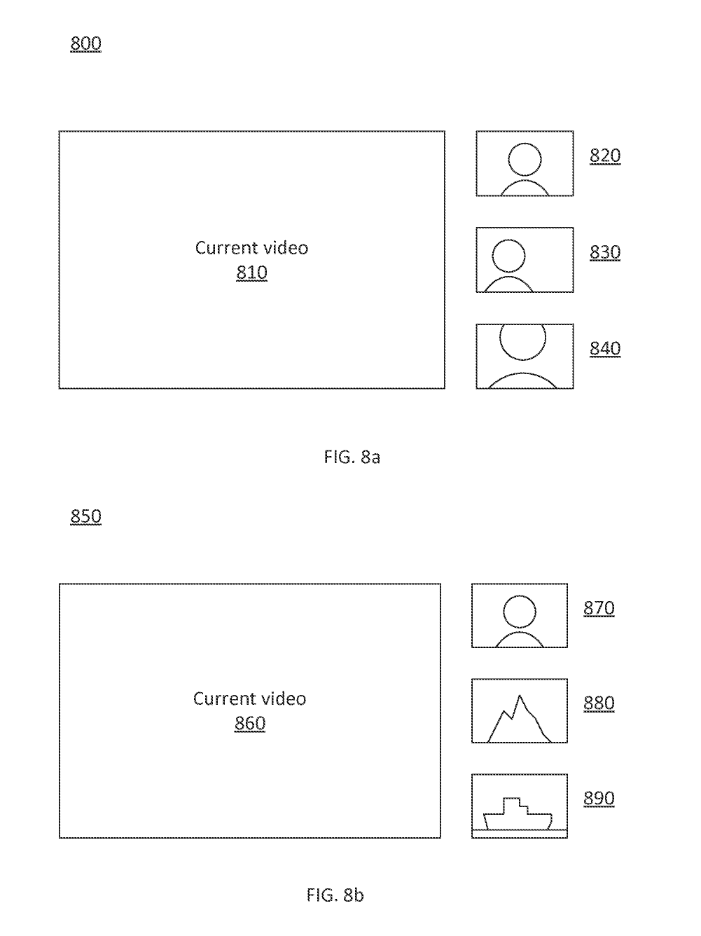

FIG. 8a illustrates a view of a content system comprising a current video and a set of suggested videos with no de-duplication, according to one embodiment. The environment 800 comprises a current video 810, and three thumbnail images 820, 830, 840 each associated with a video related to the current video 810. In the absence of de-duplication, the thumbnails 820, 830, and 840 are very similar. Each thumbnail features the same image of a face and upper body, the image only differing in size or orientation. This results in reduced utility for a user who has difficulty selecting a video to watch next based on the thumbnails.

FIG. 8b illustrates a view of a content system comprising a current video and a set of suggested videos where similar thumbnails and their corresponding related videos have been removed from the list of related videos, according to one embodiment. The environment 850 comprises a current video 860, and three thumbnail images 870, 880, and 890 having low similarity to each other. Unlike in FIG. 8a where the thumbnail images 820, 830, and 840 are highly similar resulting in reduced utility to a user, the thumbnail images 870, 880, and 890 of FIG. 8b are highly dissimilar and allow a user to easily distinguish between each of the associated videos.

What is claimed is:

1. A method for identifying a diverse selection of thumbnail images for display in a list of recommended videos in an online content system, comprising:
receiving a request for thumbnail images associated with a set of videos determined to be relevant to a current video;
accessing a set of thumbnail images and associated set of compressed representations, the set of thumbnail images associated with the set of videos;
comparing the set of compressed representations to each other to determine a measure of visual distance between each compressed representation and each other compressed representation in the set;
removing from the set a subset of those compressed representations having insufficient measures of visual distance with others of the compressed representations in the set, the measures failing to meet a minimum threshold;
identifying the remaining compressed representations in the set; and
returning the thumbnails associated with the remaining compressed representations in the set.

2. The method of claim 1, wherein compressed representations comprise a plurality of feature vectors generated based on dimensionality reduction and quantization of the associated thumbnail image.

3. The method of claim 2, wherein determining the measure of visual distance comprises computing a Euclidean distance between the feature vectors of the compressed representations.

4. The method of claim 1, wherein each of the videos in the set determined to be relevant to the current video is associated with a relevance score.

5. The method of claim 4, wherein the comparing and removing comprises:
determining a first measure of visual distance between a first and a second of the compressed representations in the set, the first and the second compressed representations associated with a first and a second video in the set, and a first and a second relevance score, respectively; and
responsive to the first measure of visual distance failing to meet a minimum threshold, removing from the set of compressed representations the first or the second compressed representation having a lower relevance score than the other.

6. The method of claim 5, wherein the first relevance score is higher than the second relevance score, and accordingly, removing the second compressed representation from the set.

7. The method of claim 5, wherein the comparing and removing further comprises:
determining a second measure of visual distance between the first and a third compressed representation in the set, the first and the third compressed representations associated with the first and a third video in the set, the third video having a third relevance score higher than the first relevance score; and
responsive to the second measure of visual distance failing to meet a minimum threshold and responsive to the third relevance score being higher than the first relevance score, removing the first compressed representation from the set.

8. The method of claim 1, further comprising:
storing the measures of visual distance between each pair of compressed representations in the set; and
wherein removing from the set the subset of those compressed representations having measures of visual distance with others of the compressed representations in the set below the minimum threshold further comprises:
accessing the stored measures of visual distance;
for each of the compressed representations,
comparing those measures of visual distance involving one of the compressed representations and that fail to meet the minimum threshold; and
removing all but one of the compressed representations having the measure of visual distance below the minimum threshold with respect to the one compressed representation.

9. The method of claim 1, further comprising:
computing the compressed representation for each of the thumbnail images; and
storing, persistently in a database, the compressed representations associated with the thumbnail images.

10. A computer program product, the computer program product comprising a non-transitory computer-readable storage medium containing computer program code for:
receiving a request for thumbnail images associated with a set of videos determined to be relevant to a current video;
accessing a set of thumbnail images and associated set of compressed representations, the set of thumbnail images associated with the set of videos;
comparing the set of compressed representations to each other to determine a measure of visual distance between each compressed representation and each other compressed representation in the set;
removing from the set a subset of those compressed representations having measures of visual distance with others of the compressed representations in the set below a minimum threshold,
identifying the remaining compressed representations in the set; and
returning the thumbnails associated with the remaining compressed representations in the set.

11. The computer program product of claim 10, wherein compressed representations comprise a plurality of feature vectors generated based on dimensionality reduction and quantization of the associated thumbnail image.

12. The computer program product of claim 10, wherein determining the measure of visual distance comprises computing a Euclidean distance between the feature vectors of the compressed representations.

13. The computer program product of claim 10, wherein each of the videos in the set determined to be relevant to the current video is associated with a relevance score.

14. The computer program product of claim 13, wherein the comparing and removing comprises:
determining a first measure of visual distance between a first and a second of the compressed representations in the set, the first and the second compressed representations associated with a first and a second video in the set, and a first and a second relevance score, respectively; and
responsive to the first measure of visual distance failing to meet a minimum threshold, removing from the set of compressed representations the first or the second compressed representation having a lower relevance score than the other.

15. The computer program product of claim 14, wherein the first relevance score is higher than the second relevance score, and accordingly, removing the second compressed representation from the set.

16. The computer program product of claim 14, wherein the comparing and removing further comprises:
determining a second measure of visual distance between the first and a third compressed representation in the set, the first and the third compressed representations associated with the first and a third video in the set, the third video having a third relevance score higher than the first relevance score; and
responsive to the second measure of visual distance failing to meet a minimum threshold and responsive to the third relevance score being higher than the first relevance score, removing the first compressed representation from the set.

17. The computer program product of claim 10, further comprising:
storing the measures of visual distance between each pair of compressed representations in the set; and
wherein removing from the set the subset of those compressed representations having measures of visual distance with others of the compressed representations in the set below the minimum threshold further comprises:
accessing the stored measures of visual distance;
for each of the compressed representations,
comparing those measures of visual distance involving one of the compressed representations and that fails to meet the minimum threshold; and
removing all but one of the compressed representations having the measure of similarity in excess of the minimum threshold with respect to the one compressed representation.

18. The method of claim 10, further comprising:
computing the compressed representation for each of the thumbnail images; and
storing, persistently in a database, the compressed representations associated with the thumbnail images.
